(19) United States
(12) Patent Application Publication
(10) Pub. No.: US 2010/0291508 A1
(43) Pub. Date: Nov. 18, 2010

(54) BIOCOMPATIBLE SHELL FOR BONE TREATMENT

(76) Inventor: Ole T. Jensen, Englewood, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 12/721,127

(22) Filed: Mar. 10, 2010

Related U.S. Application Data
(60) Provisional application No. 61/178,040, filed on May 13, 2009.

(51) Int. Cl. A61C 5/14; A61C 8/00; G06F 17/50

(52) U.S. Cl. 433/174; 128/861; 700/98; 700/119

(57) ABSTRACT

There are provided systems, methods and apparatuses related to bone augmentation shells. In particular, in accordance with an aspect, there is disclosed an apparatus for bone augmentation. The apparatus includes a biocompatible body being shaped to fit over basal supporting bone structure. The body has an interior surface defining a cavity into which bone growth material may be inserted. Additionally, the body includes a rib portion located at an apex of the body, a first surface extending downward on a first side from the rib portion and a second surface extending downward on a second side from the rib portion. At least a portion of the first and second surfaces is roughened to have a micro-topography conducive to soft tissue attachment.

### CROSS-REFERENCE TO RELATED APPLICATIONS

The present application is related to and claims priority to U.S. Provisional Patent Application No. 61/178,040, filed on May 13, 2009, entitled “Rapid Prototype Titanium Shell,” the contents of which are hereby incorporated by reference herein in their entirety.

### BACKGROUND

1. Technical Field

Aspects of the present disclosure relate generally to biocompatible shells for bone treatment and, more specifically, to methods for manufacturing biocompatible shells and techniques for implementing biocompatible shells as a bone graft strategy.

2. Background Discussion

Bones are the basic structural unit of the human body. Among other things, they provide protection for organs and support the weight of the body. Bone strength and size maybe negatively impacted by disease, trauma, and/or atrophy. With respect to the jaw bone, any reduction in size and strength may result in tooth loss as well as possible reduction in the size of the basal supporting bone which forms the basic dental skeletal structure.

There is a need in the art for improved bone treatment techniques and apparatuses that may be implemented with high precision to allow for bone regeneration and augmentation. In particular, there is a need for an integrated bone augmentation and dental implant strategy that allows for secure and precise positioning of dental implants.

### BRIEF DESCRIPTION OF THE DRAWINGS

FIG. 1 is a flowchart for creating a biocompatible shell for bone growth.

FIG. 2 is a block diagram of a system for creating biocompatible shells.

FIGS. 3A and 3B illustrate stereolithographic modeling of a jaw bone and shell, respectively.

FIG. 4 illustrates a cross-sectional view of a biocompatible shell.

FIG. 5 illustrates a side view of the biocompatible shell installed on the jaw bone.

FIG. 6 illustrates a longitudinal cross-sectional view of the installed biocompatible shell with dental implants.

FIG. 7 illustrates a top view of the installed biocompatible shell.

FIG. 8 illustrates a cross-sectional view of the installed biocompatible shell taken along line AA of FIG. 7.

FIG. 9 illustrates a perspective cross-sectional view of a segment of the installed implant taken along line BB of FIG. 7.

FIG. 10 is a flowchart illustrating steps for installing the biocompatible shell of FIGS. 4-8.

### SUMMARY

In accordance with an aspect of the disclosure an apparatus for bone augmentation is provided. The apparatus includes a biocompatible body being shaped to fit over basal supporting bone structure. The body has an interior surface defining a cavity into which bone growth material may be inserted. Additionally, the body includes a rib portion located at an apex of the body, a first surface extending downward on a first side from the rib portion and a second surface extending downward on a second side from the rib portion. In some embodiments, at least a portion of the first and second surfaces is provided with a micro-topography conducive to soft tissue attachment.

In accordance with another aspect of the disclosure a method for manufacturing a biocompatible shell is provided. The method includes determining a bone structure to which the biocompatible shell will be attached and designing the biocompatible shell based on the determined bone structure using a computer graphics program. Additionally, the method includes creating the biocompatible shell from the design by providing computer readable data to a shell generation device and roughening an outer surface of the shell.

In accordance with yet another aspect of the disclosure a rapid prototype shell assembly for bone augmentation and dental implant placement is provided. The shell includes a shell body having a generally arcuate cross-sectional shape. The shell body includes a rib portion located at an apex of the body and lingual and labial surfaces extending from the rib portion to form a cavity.

### DETAILED DESCRIPTION

Generally, there is disclosed an apparatus and method for bone graft strategy implementing biocompatible shells (also referred to as “bone forms”) that provide a structure and form for bone growth. In particular, embodiments set forth herein generally include a printable (e.g., rapid prototype) biocompatible shell that provides structure and shape for bone augmentation where bone has been resorbed, damaged, or atrophied. In some embodiments, the biocompatible shell may be implemented as a titanium shell, a titanium alloy shell, a titanium mesh shell, a titanium alloy mesh shell, a shell made of resorbable material such as a polylactate, or other shell of suitable material. In some embodiments, the biocompatible shell may be made of a titanium mesh or titanium alloy mesh formed mechanically or by hand into a desired shape and utilized in the same manner as the printed shell.

In some embodiments, a combined bone graft-dental implant strategy implements a biocompatible shell and dental implants. For a combined graft-implant strategy, the biocompatible shell may be based on stereolithographic designed alveolar jaw bone augmentation and includes fastening capacity for high profile dental implant placement. Bone Morphogenetic Protein-2 (or bone graft) may be implemented to provide a bone structure within the shell to secure the dental implants and allow for eventual removal of the biocompatible shell.

In some embodiments, computer assisted design (CAD) technology is employed to fabricate the biocompatible shell and/or the dental implants. Additionally, CAD technology may be used for creation of physical models for use in model surgery. Specifically, models of existing bone, a biocompatible shell, and implants may be created directly from computer aided drafting (CAD) source data. The models and the biocompatible shell may be fabricated in a suitable method, such as a printable method by adding material in layers.

Rapid prototyping is a common name given to a host of related technologies that are used to fabricate physical objects directly from CAD data sources. The rapid prototyping methods add and bond materials in layers to form objects such as the biocompatible shells. Such methods may also be referred to as additive fabrication, three dimensional printing, solid freeform fabrication and layered manufacturing. Stereolithography is the most widely used method of rapid prototyping technology and may be used in the production of anatomic models that are useful for tactile hands on treatment planning for alveolar surgical modification of edentulous sites for dental implants. As used herein, reference to stereolithography, printing, rapid prototyping, or the like, should be understood to include any of the class of printable techniques and use of such terms is not intended to be exclusive. Further, it should be appreciated that other techniques may be implemented to create the models and/or shells and dental implants. For example, in some embodiments, a milling technique, such as computer numerical controlled (CNC) milling, may be implemented. Additionally, in some embodiments, the shell may be mechanically and/or manually formed with titanium or titanium alloy mesh.

In some embodiments, a titanium shell made via stereolithography to shape bone augmentation is implemented. When surgically placed, the shell guides and secures dental implants into appropriate positions. Design and placement planning of both the shell and the implants may be performed in a graphical computer environment and may be based on radiographic images of existing bone. Hence, graphical computer planning software and print technologies such as stereolithography are implemented to fabricate the titanium shell to prescribed dimensions.

The shell may be secured to the existing bone by trans-osseous fastening screws. Bone Morphogenetic Protein (BMP) or bone graft material is injected into an interior space of the shell to fill the augmentation requirement. Dental implants are also installed into the shell. Surgical application of dental implants, placed in high profile are secured by the biocompatible shell at a rigid spine that has specific perforating holes (at the alveolar crest) through which cover screws pass to secure the implants. Following a bone-healing period (e.g., six months time), the titanium shell is removed and bone and osseo-integrated implants remain. To prevent dehiscence, the titanium shell may be laser etched on an outer surface to promote soft tissue attachment.

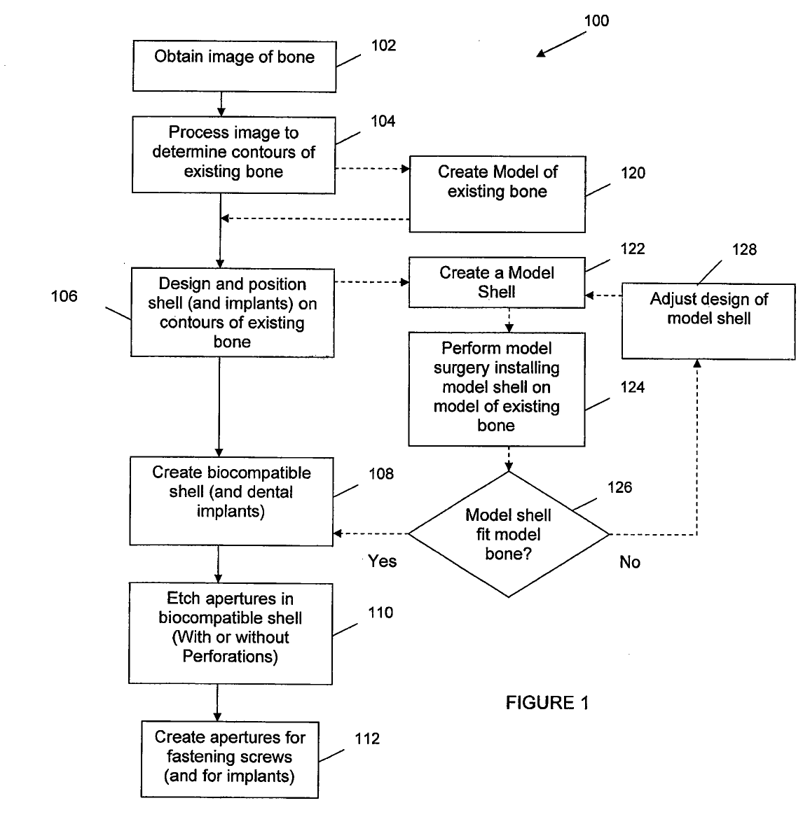

Turning to the figures and referring initially to FIG. 1, a flow chart illustrating a method 100 of manufacturing a titanium shell that may function as a bone graft mold and as a dental implant stent is illustrated. The method 100 includes obtaining a radiographic image of bone that has been damaged, deteriorated, or otherwise will be constructed or re-constructed (Block 102). In some embodiments, a CT scan is taken of bone that has been damaged and/or resorbed. For example, a CT scan image of a damaged or demineralized jaw bone may be taken if reconstruction of jaw bone and placement of dental implants are desired.

The radiographic image is used to determine the contours of the existing bone structure (Block 104). In some embodiments, the determination of contours may be automated (i.e., computer software evaluates the radiographic image and determines the dimensions of the existing bone). In other embodiments, a user may determine the contours of the existing bone based on viewing the radiographic image. A biocompatible shell is designed to fit the existing bone (Block 106). Specifically, using computer software and the radiographic image, a user may design the shape of the biocompatible shell to achieve a desired amount of bone augmentation and/or to sufficiently secure dental implants. A doctor, such as an orthopedic surgeon or a maxillofacial surgeon, may design the biocompatible shell using the computer software. In other embodiments, a technician may design the biocompatible shell under supervision of a doctor. In some embodiments, the designing of the biocompatible shell may be automated or semi-automated. That is, software may be provided that determines the shape of the existing bone and provides a suggested shell design. A user may then fine-tune the shape and design of the suggested shell design. In some embodiments, the user may accept the shell suggested and designed by the software.

Once the biocompatible shell has been designed, the biocompatible shell is created (Block 108). The biocompatible shell may be created through a rapid prototyping process or a milling process. In some embodiments, the biocompatible shell may created by manually or mechanically forming titanium or titanium alloy mesh into a desired shape, such as by molding the shell over a model.

An outer surface of the biocompatible shell may be roughened, etched or imprinted (Block 110). The roughening, etching or imprinting of the outer surface helps to encourage tissue attachment to the shell to prevent dehiscence after the shell has been installed. The process may include one or more of the following techniques: imprint etching and acid perforation, laser imprinting, mechanical alteration, chemical surface alteration, embossing, or other suitable technique. Ionization techniques, Acetate mineralization, and/or blasting techniques may also, or alternatively, be implemented. In addition to the etching the outer surface, an inner surface of the shell may be polished, or otherwise made smooth, in some embodiments.

With respect to laser etching, the etching may be performed at a suitable wavelengths and powers for etching titanium or titanium alloy. The depth of the etching may vary based on the material used for the shell and the power and wavelength of the laser used for the etching. Appropriate wavelengths and power levels may be empirically determined. In some embodiments, the etching may include perforations through the shell.

The perforations may be distributed across the entire shell or may be located in specific locations on the shell, such as in locations that will be in contact with soft tissue.

In some embodiments, the perforations may be randomly distributed and in other embodiments the perforations may be uniformly spaced and/or arranged in lines and/or columns or other patterns. The perforations extend through the shell and may have diameters ranging from approximately less than 0.1 mm to 1.5 mm. In some embodiments, each of the perforations may have approximately the same size diameter, such as 0.25 mm, for example.

Apertures may also be created through the shell for fastening members, such as fastening screws, and for the installation of dental implants if the shell is to be implemented in a combined bone augmentation/dental implant strategy (Block 112). The fastening members are used to attach the shell to existing bone structure. As such, the apertures for fastening members may generally be located about a lower periphery of the shells. The apertures of the dental implants may be generally located at or near an apex or crest of the shell, as the dental implants are generally installed near the alveolar crest.

In some embodiments, a radiographic image of bone that is to be augmented may be digitally stored and uploaded to a remote network accessible site. The network accessible site may be accessed via the Internet, a local area network, a wide area network, or other network connection. Once uploaded, the image may be used to design the biocompatible shell and/or the dental implants. Specifically, a doctor or technician may access the image and design the biocompatible shell based on the image. Thus, the network accessible site may be configured to run image processing and graphics software. In some embodiments, the site may provide computer aided drafting software for use in designing the shell. In some embodiments, the site may allow for design of the shell using a first program and export the design to a second program for creation of the shell. In some embodiments, the shell may be designed at a computer workstation local to the technician or doctor and, subsequently, the design may be uploaded to the site.

Once the design is created and received at the site, the doctor, technician or other individual may place an order to have the designed shell manufactured. The shell may be manufactured and then shipped to the doctor for installment. Thus, the shell is made according to custom specifications set forth by the doctor or technician.

Optionally, in some embodiments, a model of the bone structure and a model of the biocompatible shell may be created to aid in designing and properly positioning the biocompatible shell and/or dental implants relative to the existing bone. The creation and use of models may be optionally implemented in addition to the previously described steps. In particular, as illustrated in FIG. 1, a model of the existing bone may optionally be created from the radiographic image (Block 120). Additionally, once the shell has been designed (Block 106), a model shell may be created (Block 122). In one embodiment, both the model shell and the model bone may be created through CAD modeling and the stereolithic process.

A model surgery may be performed by installing the model shell on the model bone (Block 124). Through the model surgery, it is determined if the model shell fits the model bone (Block 126). Determining whether the model shell fits the model bone may help to determine if the designed shell will fit with the existing bone structure. If the model shell does not fit the model bone, the design of the model shell (and the design of the shell) may be adjusted (Block 128).

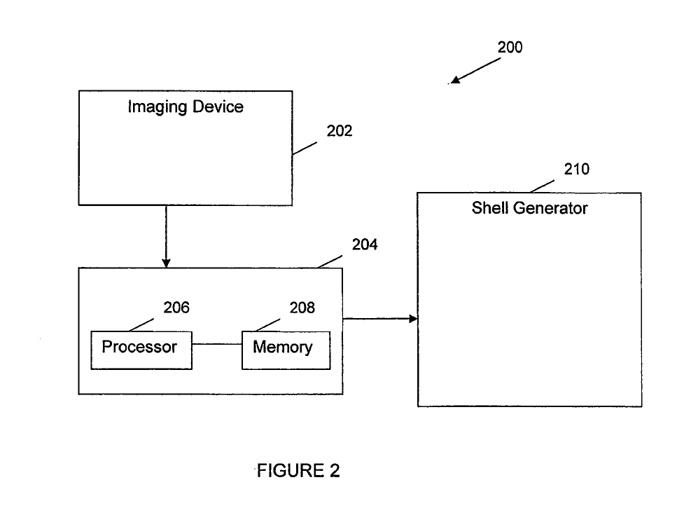

FIG. 2 illustrates a block diagram of a system 200 that may be used for the manufacture of the biocompatible shell. The system 200 includes an imaging device 202 that obtains images of the existing bones structure in the area where a bone graft is to occur. As described above, the imaging device 202 maybe a radiographic device such as a CT scanner or other suitable device. The imaging device 202 provides the images to a computing device 204. The computing device 204 may be local to the imaging device 202 in some embodiments. In other embodiments, the computing device 204 may be remotely located from the imaging device 202 and images may be provided to the computing device 204 via a network connection, a computer readable medium, such as a DVD, a flash drive, or other suitable means.

The computing device 204 includes a processor 206 and a memory 208. The processor 206 is coupled to the memory 208 and is configured to run software, programs, applications, etc., stored in the memory 208. For example, the memory 208 may store computer aided drafting programs may be executed by the processor 206 to allow for rendering, creation and manipulation of images, such as images of the shell. The computing device 204 may also include I/O devices (not shown) to provide output to a user (such as images via a display) and a to receive input from a user (such as via a keyboard and a mouse).

The images of existing bone structure may be stored in the memory 208 and read by the processor 206. Additionally, images of the shell may be stored in the memory 208 and provided to a shell generator 210 for creation of the shell. In some embodiments, the shell generator may be a stereolithography device, a CNC mill, or the like, and may be configured to automatically form the shell, or models from the information (i.e., images) provided from the computing device 204. In some embodiments, computing device 204 may provide the images to the shell generator 210 via a network connection. It should be appreciated that the system 200 shown in FIG. 2 is simplified and an actual implementation may include more devices. For example, each of the imaging device 202 and the shell generator 210 may have dedicated computing devices with which the computing device 204 may communicate.

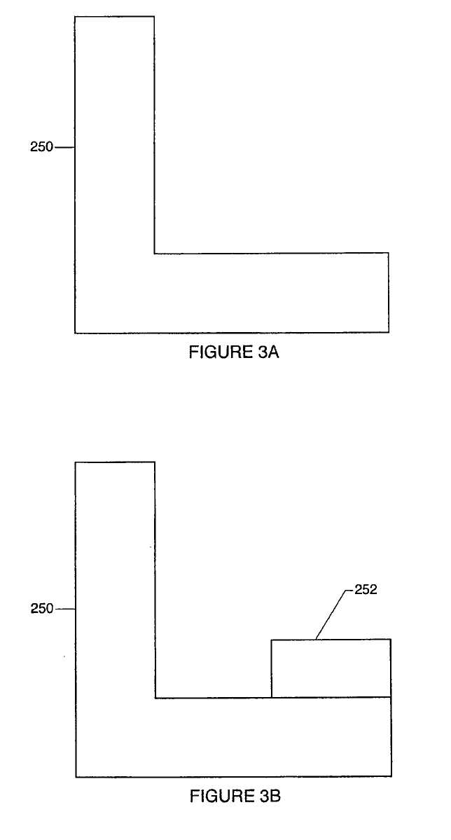

FIG. 3A illustrates a profile view of an example model 250 of demineralized bone. As mentioned above, the model 250 may be created using a stereolithic process from radiographic images. Generally, the stereolithic process may include selective solidifying of a photo curable, clear liquid acrylic resin, layer by layer, using an ultraviolet laser beam to produce a transparent, high precision anatomical facsimile model that includes thin bony layers and closed cavities.

FIG. 3B illustrates a model shell 252 placed on the model bone 250. The model shell 252 may be modified as needed to achieve the desired shape and dimensions based on the modeled bone 250.

To facilitate modifications and analysis during the model surgery, the model bone produced by the stereolithic process may be mounted on an articulator with an appropriate vertical dimension and bite relation to allow a surgical prosthetic team to identify and address aveolar deficiency or malrelation. The model includes the hard tissue elements and, as such, can be used to determine any deviation from the alveolar plane.

The model surgery using stereolithographically generated bone structure allows for visualization of key anatomic structures. For example, the model surgery may allow for visualization of the alveolar plane, inferior alveolar nerve, pneumatization of maxilla, and dental roots, among other things.

The model surgery also allows for modeling surgical guides for implant placement may be made by a rapid prototyping machine using a vat of photo-polymerizing resin from which a laser moves in segmental cross-sectional increments to polymerize an approximately 1 mm layer of resin based on the format of the CT image. Subsequent layers are polymerized on top of this layer until the entire CT image has been polymerized in resin, creating a completed model of the bone. The stereolithographic machine also reads CT planned cylindrical guides corresponding to each implant such that it polymerizes resin around each site for subsequent placement of guide tubes which are then fitted inside the cylindrical tubes.

In some embodiments, once the optional model surgery has been completed, and the model shell fits the model bone, the biocompatible shell may be created (Block 108). In particular, the biocompatible shell may be created of titanium, titanium alloy, or any other suitable material based on the designed and modeled shell. In some embodiments, the shell may be made of a resorbable material such as a polyactate, or other such material. The shell may be created through a suitable process. In some embodiments, the shell may be machined. In other embodiments, a stereolithographic process may be implemented to create the shell, in accordance with known stereolithographic techniques.

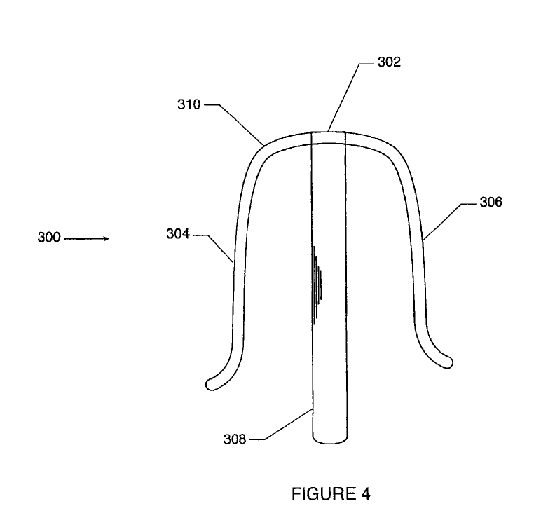

FIG. 4 illustrates a cross-sectional view of a biocompatible shell and guide. The general shape of the cross-section of the shell 300 may be arcuate and in some cases similar to a horseshoe shape. In some embodiments, the width of the shell 300 is thicker near a top ridge 302 (or rib) and tapers narrower on both lingual and labial sides 304 and 306, respectively. Specifically, the ridge 302 may be approximately 1.5 to 3.0 mm (e.g., 2.3 mm) thick while the ends of the lingual and labial sides 304 and 306 may be approximately 0.5 to 2.6 mm (e.g. 1.3 mm) thick.

Surgical guides may be created concurrently with the manufacture of the shell 300 using the same process as used for the shell. A guide 308 is illustrated in FIG. 4. The guide 308 may be made of a suitable material, such as a metal, and in some embodiments may have a cylindrical shape with a hollow center through which tools, biomedical implants, or devices may pass. For example, dental implants may pass therethrough, the guide directing the positioning of the dental implants. The surgical guides can be tooth, soft tissue or bone supported. Additionally or alternatively, the guides may be supported by the shell 300.

After placement of the dental implants, the guide 308 is removed and may be discarded. One study determined these types of guides were accurate to within 0.95 mm in the maxilla and 1.28 mm in the mandible in 110 implants placed clinically. Tooth supported guides were slightly more accurate than bone supported guides with an angular deviation of 2 to 4 degrees in tooth born and 3 to 7 degrees in bone guides. This was only slightly less accurate than found in vitro.

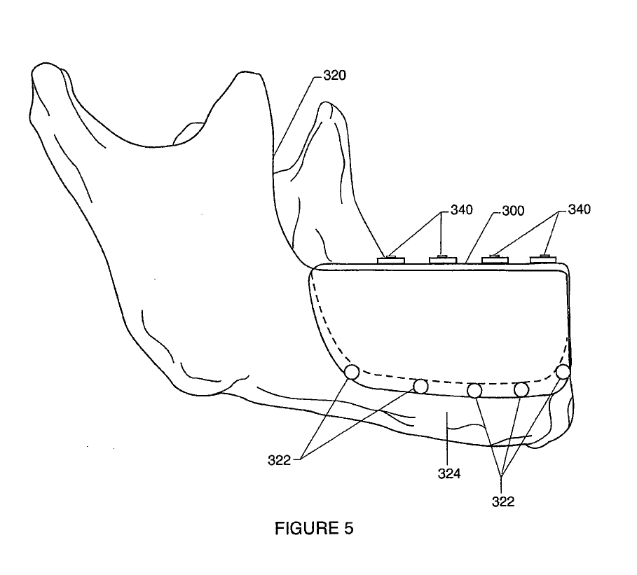

FIG. 5 is a profile view of the shell 300 installed on a jaw bone 320. The shell 300 may be held in place with shell fastening screws 322 which screw into atrophic bone 324 of the jaw bone 320. The shell fastening screws 322 may be installed in pre-drilled apertures through the shell 300. In some embodiments, the apertures may be uniformly spaced about a lower periphery of the shell 300. In other embodiments, the placement of the apertures (and hence the placement of the fastening screws) may be customized according to existing bone structure as determined by the radiographic image of the existing bone. For example, the apertures may be located on the shell in locations that will allow the shell to be securely positioned relative to the bone rather than in regions that may have reduced strength, density, and/or structure.

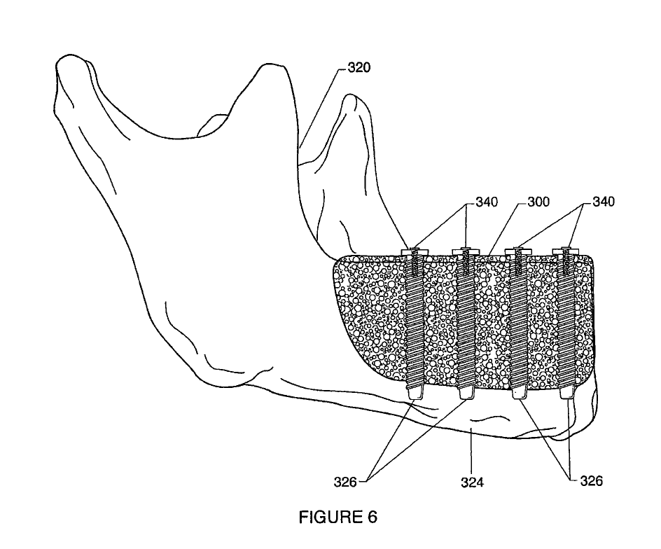

Additionally, apertures may be located along the ridge 302 for installing dental implants. In FIG. 5, cover screws 340 on the dental implants 326 may be seen. FIG. 6 shows a longitudinal cross-section view of the shell 300 so that the dental implants 326 may better be seen. The shell 300 functions as a stent for the dental implants 326 to provide proper placement and angulation for the implants 326. Although the dental implants 326 are illustrated as being installed vertically in FIG. 6, it should be appreciated that the implants may be installed at various angles. For example, the implants 326 may be installed at angles between 17 degrees to 30 degrees. Additionally, in some embodiments, there may be more or fewer dental implants. For example, in some embodiments an “All on 4” strategy may be implemented where all teeth are supported by 4 dental implants.

In some embodiments, when installed, the dental implants 326 may extend into the existing bone 324. As such, the existing bone 324 and the shell 300 support the dental implants. In some embodiments, the dental implants 362 may be installed into portions of the existing bone 324 that allows for secure fixation of the dental implants. That is, in areas where the existing bone 324 is sufficiently strong to help support the dental implants 326 until the bone graft may help support the implant. The determination as to strength of the existing bone and structure of the existing bone may be extracted from the radiographic images of the existing bone 324.

FIG. 6 also shows the interior of the shell 300 filled with bone graft material 330 may be seen. The bone graft material fills the interior of the shell 300 and surrounds the dental implants 326. As the bone graft material 330 hardens to form bone, the dental implants become secure in the newly formed bone and the newly formed bone supports the dental implants.

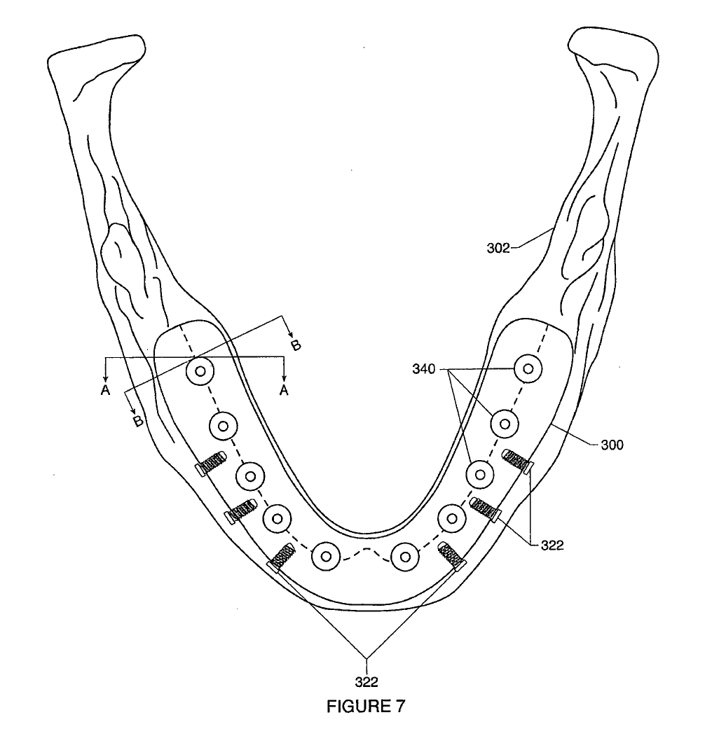

FIG. 7 illustrates a top view of the shell 300 installed on the jaw bone 302. Cover screws 340 may cover the dental implants 326. Additionally, the cover screws 340 provide structural support to the dental implant to hold the implants in a desired location and/or orientation while the bone graft heals. As may be seen, the shell 300 may have a generally arcuate shape that generally conforms to the shape of the jaw bone 302. It should be appreciated that in some embodiments the shell 300 may have different shapes depending need for bone growth and/or implants. For example, in some embodiments, the shell 300 may have a generally straight shape (such as a short segment of the shell 300 that extends across the front of the jaw bone 302).

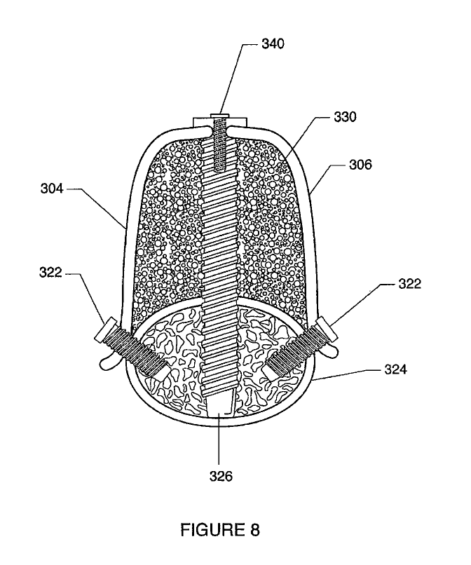

The cover screws 340 may more easily be seen in FIG. 8 which is a segmental cross-sectional view of the installed shell 300 along line AA of FIG. 7. Additionally, FIG. 8 shows shell fastening screws 322 installed on both sides of the shell 300 to secure the shell to the atrophic bone 324. In some embodiments, the lingual side 304 of the shell 300 may have a different length from the labial side 306.

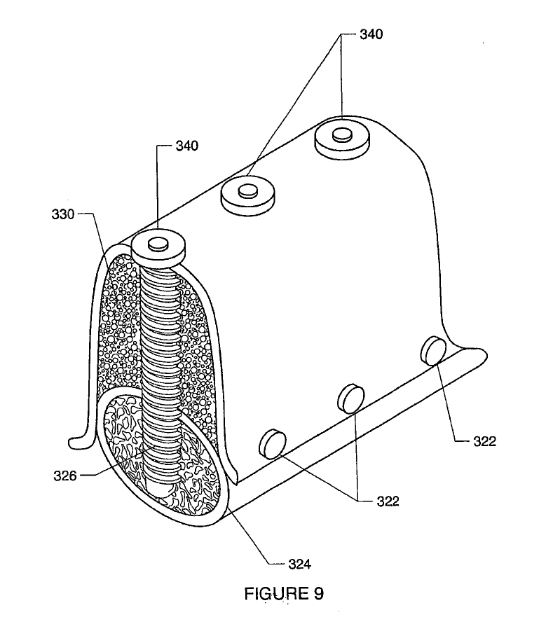

FIG. 9 is a segmental perspective cross-sectional view of the installed shell 300 taken along line BB of FIG. 7 showing the spacing of the dental implants 326 (and cap screws 340) and the fastening screws 322. The cap screws 340 run along the top ridge of the shell 300. When the bone has healed into the shape of the shell 300 and the shell is removed, the dental implants allow for placement of teeth along an alveolar crest of the newly formed/augmented bone structure (i.e., may be longer or shorter).

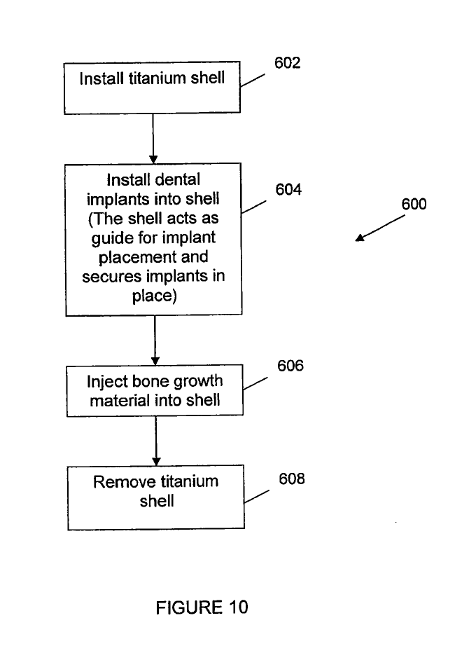

A technique 600 for installing the shell 300 is illustrated as a flowchart in FIG. 10. The technique 600 includes installing the shell 300 on the atrophic bone 324 (Block 602). High profile dental implants 326 are installed into the atrophic bone 324 (Block 604). The shell 300 acts as a guide for implant placement and helps hold the implant in place. Bone growth material is then injected into the shell 300 (Block 606). In each of the above-described cross-sectional views of the installed shell 300 (FIGS. 6, 8 and 9), bone growth material 330 may be seen. Specifically, bone growth material such as BMP-2 is injected into the space between the shell 300 and the atrophic bone 324. The bone growth material is allowed to heal for a period of time (e.g., approximately six months) after which the shell 300 is removed (Block 608). The removal of the shell 300 reveals an augmented bone that secures the dental implants 326 in place.

Although the present subject matter has been described with respect to particular embodiments, it should be appreciated that changes to the described embodiments and/or methods may be made yet still embraced by alternative embodiments of the invention. For example, one alternative embodiment, may include milling the titanium shell rather than producing the shell through a rapid prototyping process. Specifically, a computer numerical control (CNC) milling machine may be use to mill a titanium, titanium alloy (or other material) blank to achieve the desired shape, contours and size of the shell. The CNC milling machine may operate based on CAD drawings of the shell, similar to the operation of the rapid prototype.

Additionally, although each of the drawings illustrating the biocompatible shell show a solid construction made from a unitary piece of material, in some embodiments, the biocompatible shell may be made of a mesh, such as a titanium mesh. The titanium mesh may be mechanically or manually manipulated to conform with a desired shape. The titanium mesh may serve the same functions as the biocompatible shell having a solid construction.

Further, although several embodiments were directed to a combined bone graft and dental implant strategy, it should be appreciated that the biocompatible shell and the method of manufacturing the shell may be implemented in accordance with various bone graft strategies. For example, a biocompatible shell may be used in bone graft strategies for an orbital bone, a zygomatic bone, a femur bone or other bone. Accordingly, the proper scope of the present invention is not to be limited by the embodiments described above but, rather, defined by the claims herein.

1. An apparatus for bone augmentation of existing bone structure comprising:
a biocompatible body being shaped to fit over basal supporting bone structure, the body having an interior surface defining a cavity and the body comprising:
a rib portion located at an apex of the body;
a first surface extending downward on a first side from the rib portion; and
a second surface extending downward on a second side from the rib portion, at least a portion of the first and second surfaces being roughened to have a micro-topography conducive to soft tissue attachment, wherein the first and second surfaces are configured to interface with existing bone when installed and, wherein further, the cavity defines contours for bone growth.

2. The apparatus of claim 1 wherein the rib portion has a thickness of approximately 1.5 to 3.0 mm.

3. The apparatus of claim 1 wherein the first and second surfaces each have a thickness of approximately 0.5 to 2.6 mm.

4. The apparatus of claim 1 wherein the first and second surfaces taper to approximately 0.5 to 2.6 mm thick from the rib portion.

5. The apparatus of claim 1 wherein the rib portion comprises one or more apertures for cover screws to interface dental implants.

6. The apparatus of claim 1 wherein the first surface extends downward further from the rib portion than the second surface.

7. The apparatus of claim 1 comprising one or more apertures in the first and second surfaces for trans-osseos fastening screws.

8. The apparatus of claim 1 wherein the biocompatible body has microperforations of 0.1 to 1.5 mm diameter.

9. A method for manufacturing a biocompatible shell comprising:
determining a bone structure to which the biocompatible shell will be attached based on an image of the bone structure;
designing the biocompatible shell based on the determined bone structure, using computer graphics software executing on a graphics device;
storing the biocompatible shell design in a computer readable medium;
providing the biocompatible shell design to a shell generator;
a processor reading the biocompatible shell design and creating the biocompatible shell from the design; and
roughening an outer surface of the shell.

10. The method of claim 9 wherein determining a bone structure comprises taking a CT scan of the bone structure.

11. The method of claim 9 further comprising:
creating a stereolithic model of the determined bone structure;
creating a stereolithic model of the biocompatible shell; and
performing a model surgery with the model shell and model bone structure.

12. The method of claim 9 wherein the shell comprises one of: solid titanium, solid titanium alloy, titanium mesh, titanium alloy mesh, or poly lactate.

13. The method of claim 9 comprising using rapid prototype technology to create the implant shell.

14. The method of claim 9 comprising milling a titanium or titanium alloy blank to create the biocompatible shell.

15. A rapid prototype shell assembly for bone augmentation and dental implant placement comprising:
a solid shell body having a generally arcuate cross-sectional shape comprising:
a rib portion located at an apex of the body used to secure dental implants during bone graft healing; and
lingual and labial surfaces extending from the rib portion to form a cavity;
wherein the solid shell body is configured to at least partially support surgical guides and dental implants during a bone graft surgery and a recovery period.

16. The rapid prototype shell assembly of claim 15 wherein the lingual and labial surfaces have a roughened surface conducive to soft tissue attachment.

17. The rapid prototype shell assembly of claim 15 further comprising one or more high profile dental implants located within the cavity of the shell body.

18. The rapid prototype shell assembly of claim 17 further comprising cover screws located over the one or more high profile dental implants, wherein the cover screws extend through the shell body to interface the dental implants and provide structural support for the dental implants.

19. The rapid prototype shell assembly of claim 15 further comprising one or more trans-osseous fastening screws configured to extend through the labial surface.

20. The rapid prototype shell assembly of claim 15 further comprising one or more trans-osseous fastening screws configured to extend through the lingual surface.

21. The rapid prototype shell assembly of claim 15 wherein the shell comprises an arcuate shape when viewed from above.
